(19) United States
(12) Patent Application Publication
(10) Pub. No.: US 2021/0172159 A1
(43) Pub. Date: Jun. 10, 2021

(54) Flow Controller and Bubbler

(71) Applicants: Huaqiang ZHOU, Xiamen (CN); Xiamen Water Nymph Sanitary Technology Co., Ltd., Xiamen (CN)

(72) Inventor: Huaqiang ZHOU, Xiamen (CN)

(21) Appl. No.: 17/113,365

(22) Filed: Dec. 7, 2020

(30) Foreign Application Priority Data
Dec. 10, 2019 (CN) 201911258455.2

(51) Int. Cl. E03C 1/084

(52) U.S. Cl. CPC E03C 1/084

(57) ABSTRACT

The invention discloses a flow controller and a bubbler. The flow controller comprises a shell and a sheet part. A water outlet is formed in the bottom of the shell. The top of the shell is open. The sheet part covers the water outlet. At least two elastic legs are disposed on the sheet part, and the sheet part is supported in the shell through the legs. A flow control part for changing the distance between the bottom of the shell and the sheet part is disposed around the water outlet, and the sheet part covers at least part of the flow control. The flow control part can control the outlet flow to meet different flow requirements. The finish machining area of the flow control part is small, so that the machining difficulty is lowered, the machining amount is reduced, and the finish machining effect is improved.

### CROSS-REFERENCE TO RELATED APPLICATIONS

The application claims priority to Chinese patent application CN 201911258455.2, filed on Dec. 10, 2019, the entire contents of which are incorporated herein by reference.

### TECHNICAL FIELD

The invention relates to the technical field of water saving of bath products, in particular to a flow controller and a bubbler.

### BACKGROUND

Flow control devices are typically arranged in bath water outlet products such as faucets, showers or bubblers on the present market to control the outlet flow not to change along with the increase of water pressure when the inlet water pressure reaches a certain degree, so as to keep the outlet flow basically constant. In this way, the water outlet products can obtain the same flow under different water pressure conditions and can realize a stable water outlet effect, water is saved, and the comfort is guaranteed.

Chinese Utility Model Patent Application No. 201120571183.4 discloses a flow controller which is designed in such a manner: an elastic body is disposed in a shell, and a gap between the elastic body and the shell is the flow area; when the water pressure increases gradually, the flow area will become smaller gradually to keep the flow stable; however, in case of different outlet flow requirements, the flow area of the flow controller cannot be changed, and consequentially, the flow output cannot be controlled.

### SUMMARY

The technical issue to be settled by the invention is to provide a flow controller which can control the outlet flow by changing the flow area, and also provides a bubbler.

To settle the aforesaid technical issue, the technical solution adopted by the invention is as follows: a flow controller comprises a shell and a sheet part, wherein a water outlet is formed in the bottom of the shell, the top of the shell is open, the sheet part covers the water outlet, at least two elastic legs are disposed on the sheet part, the sheet part is supported in the shell through the legs, a flow control part for changing the distance between the bottom of the shell and the sheet part is disposed around the water outlet, and the sheet part covers at least part of the flow control part.

The invention has the following beneficial effects: the flow control part around the water outlet is used to change the distance between the bottom of the shell and the sheet part to change the flow area which is originally the space between the bottom of the shell and the sheet part into the space between the flow control part and the sheet part, and the distance between the flow control part and the sheet part is in direct proportion to the flow area, so the flow area can be changed to control the outlet flow to meet different flow requirements. In addition, to keep the outlet flow stable, the precision of the side, facing the sheet part, of the bottom of the shell should be high; after the flow control part is additionally arranged, the finish machining area of the flow control part is smaller than the area of the bottom of the entire shell, so that the machining difficulty is lowered, the machining amount is reduced, and the finish machining effect is improved.

### BRIEF DESCRIPTION OF DRAWINGS

FIG. 1 is a disassembled structural view of a flow controller in Embodiment 1 of the invention.

FIG. 2 is a vertical sectional view of a shell of the flow controller in Embodiment 1 of the invention.

FIG. 3 is a vertical sectional view of the flow controller in Embodiment 1 of the invention.

FIG. 4 is a disassembled structural view of a flow controller in Embodiment 2 of the invention.

FIG. 5 is a vertical sectional view of a shell of the flow controller in Embodiment 2 of the invention.

FIG. 6 is a disassembled structural view of a flow controller in Embodiment 3 of the invention.

FIG. 7 is a vertical sectional view of the flow controller in Embodiment 3 of the invention.

### DETAILED DESCRIPTION OF THE EMBODIMENTS

The technical contents, purposes and effects of the invention will be described below in conjunction with the embodiments and accompanying drawings.

The key conception of the invention lies in that a flow control part is disposed at the bottom of a shell and the flow controller can output different outlet flows according to different distances between the flow control part and a sheet part.

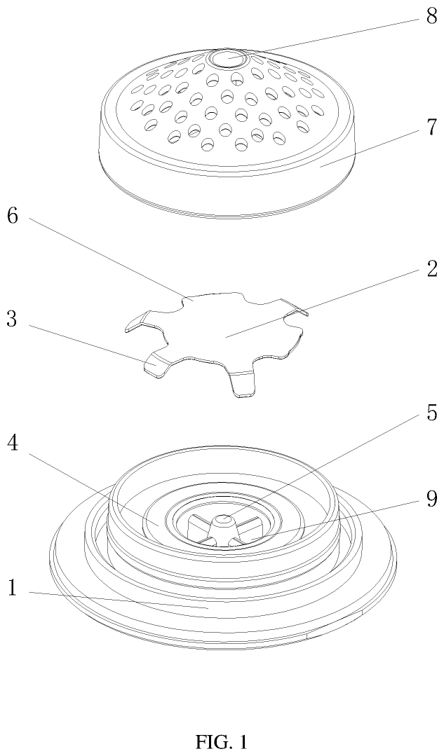

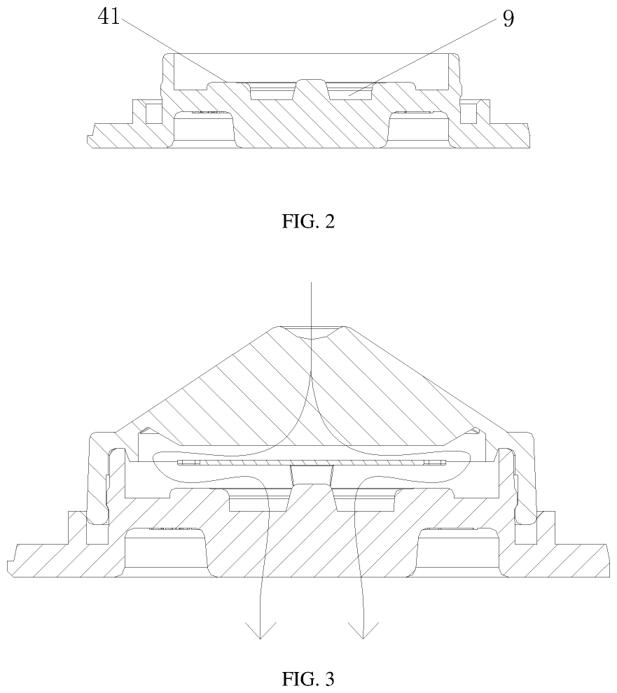

Referring to FIG. 1 to FIG. 6, the invention provides a flow controller which comprises a shell and a sheet part, wherein a water outlet is formed in the bottom of the shell, the top of the shell is open, the sheet part covers the water outlet, at least two elastic legs are disposed on the sheet part, the sheet part is supported in the shell through the legs, a flow control part for changing the distance between the bottom of the shell and the sheet part is disposed around the water outlet, and the sheet part covers at least part of the flow control part.

The operating principle of the invention is as follows: the top of the shell serves as a water inlet end, and the water outlet in the bottom of the shell serves as a water outlet end; in the water inflow process, water from the water inlet end impacts the sheet part to flow to the water outlet end along a space between the sheet part and the shell; with the gradual increase of the water pressure, the distance between the sheet part and the bottom of the shell decreases under pressure, the flow area becomes smaller, the flow velocity increases along with the increase of the water pressure, and because the flow is the product of the flow velocity and the flow area, the flow output via the water outlet is kept stable by decreasing the flow area with the increase of the flow velocity. Under the same water pressure, if the distance between the flow control part and the sheet part is smaller than the distance between the bottom of the shell and the sheet part, the water space between the flow control part and the sheet part will become smaller, and the water flow decreases along with the decrease of the flow area; similarly, if the distance between the flow control part and the sheet part is greater than the distance between the bottom of the shell and the sheet part, the water space between the flow control part and the sheet part becomes larger, the flow area increases, and the outlet flow increases. The flow area depends on the distance between the flow control part and the sheet part, and the outlet flow depends on the flow area.

From the above description, the invention has the following beneficial effects: the flow control part around the water outlet is used to change the distance between the bottom of the shell and the sheet part to change the flow area which is originally the space between the bottom of the shell and the sheet part into the space between the flow control part and the sheet part, and the distance between the flow control part and the sheet part is in direct proportion to the flow area, so the flow area can be changed to control the outlet flow to meet different flow requirements. In addition, to keep the outlet flow stable, the precision of the side, facing the sheet part, of the bottom of the shell should be high; after the flow control part is additionally arranged, the finish machining area of the flow control part is smaller than the area of the bottom of the entire shell, so that the machining difficulty is lowered, the machining amount is reduced, and the finish machining effect is improved.

Furthermore, the flow control part is a hollow cylinder with an inner diameter greater than or equal to the diameter of the water outlet, and the distance between the hollow cylinder and the sheet part is smaller than the distance between the sheet part and the bottom of the shell.

From the above description, the distance between the hollow cylinder around the water outlet and the sheet part is smaller than the distance between the sheet part and the bottom of the shell to decrease the flow area, so that the outlet flow can be decreased; in addition, the finish machining area of the hollow cylinder is smaller than the area of the bottom of the entire shell, so that the finish machining difficulty is low.

Furthermore, a groove is formed in the top end of the hollow cylinder and is located within the coverage area of the sheet part.

From the above description, the groove is formed in the hollow cylinder to stabilize the flow, so that fluctuations of the outlet flow caused by an excessive water pressure are avoided.

Furthermore, the flow control part is a recessed groove.

From the above description, the distance between the recessed groove around the water outlet and the sheet part is greater than the distance between the sheet part and the bottom of the shell, so that the flow area is enlarged, and the outlet flow can be increased.

Furthermore, the flow controller further comprises a top cover, wherein a water hole is formed in the top cover, and the top cover is fixedly connected to the top of the shell.

From the above description, the sheet part is disposed between the top cover and the shell, so that the sheet part will not be separated from the shell under an elastic effect when impacted by the water pressure.

Furthermore, a limiting rib for partitioning the water hole is disposed at the water hole in the top cover, a limiting pillar is disposed on the limiting rib and is located between the top cover and the sheet part, and a gap is reserved between the limiting pillar and the sheet part.

From the above description, the limiting rib is disposed on the top cover to partition the water hole, and the limiting pillar is disposed on the limiting rib to limit the position of the sheet part, so that the situation where the legs are erected on the inner wall of the shell or deviate when the sheet part is impacted by the water pressure is avoided.

Furthermore, the top cover is conical, the water hole is formed in the top of the top cover, and at least one auxiliary water hole is formed in a conical surface of the conical top cover and is smaller than the water hole in size.

From the above description, the water hole is aligned with the center of the sheet part, and the auxiliary water hole in the conical surface faces the sheet part, so that it is ensured that water directly flows to the sheet part at a high flow via the water hole and also flows to the sheet part via the auxiliary water hole in the conical surface.

Furthermore, a partition rib for partitioning the water outlet is disposed at the water outlet, at least one pillar is disposed on the partition rib, the top end of the pillar is higher than the top end of the flow control part and is also higher than the bottom of the shell, and a space is reserved between the pillar and the sheet part.

From the above description, when the sheet part descends under water pressure, the pillar can prevent the sheet part from sealing the water outlet in the bottom of the shell; the pillar is disposed on the partition rib to ensure that the support position of the pillar is close to the center of the sheet part, so that the situation where the sheet part deviates when supported by the pillar, and consequentially, the flow control effect is affected is avoided.

Furthermore, at least one extension part is disposed on the sheet part.

From the above description, the extension part can enlarge the water pressure-bearing area of the sheet part, thus expanding the action range of the sheet part and improving the stability of the outlet flow.

Furthermore, a bubbler comprises the flow controller.

From the above description, the flow controller is mounted in the bubbler to control the flow in the bubbler.

Referring to FIG. 1 to FIG. 3, Embodiment 1 of the invention is as follows:

This embodiment provides a flow controller which comprises a shell 1, a sheet part 2 and a top cover 7, wherein a water outlet 9 is formed in the bottom of the shell 1, and the top of the shell 1 is open.

The top cover 7 is fixedly connected to the top of the shell 1, the top cover 7 is conical, the water hole 8 is formed in the top of the top cover 7, auxiliary water holes are regularly formed in a conical surface of the conical top cover 7, and the diameter of the auxiliary water holes is smaller than that of the water hole 8.

A flow control part 4 for changing the distance between the bottom of the shell 1 and the sheet part 2 is disposed around the water outlet 9.

The flow control part 4 is a hollow cylinder 41, the inner diameter of the hollow cylinder 41 is equal to the diameter of the water outlet 9, and the distance between the hollow cylinder 41 and the sheet part 2 is smaller than the distance between the sheet part 2 and the bottom of the shell 1.

A partition rib for partitioning the water outlet 9 is disposed at the water outlet 9, a pillar 5 is disposed on the partition rib and is located at the center of the water outlet 9, the top end of the pillar 5 is higher than the top end of the hollow cylinder 41 and is also higher than the bottom of the shell 1, and a space is reserved between the pillar 5 and the sheet part 2.

Four elastic legs 3 and two extension parts 6 for enlarging the area of the sheet part are disposed on the sheet part 2, and the four legs 3 and the two extension parts 6 are located on the edge of the sheet part 2 and are spaced apart from one another.

Wherein, the number of the legs 3 may be two, three or more, and the number of the extension parts 6 may be one, two or more.

The sheet part 2 is supported in the shell 1 through the four legs 3.

The sheet part 2 covers the water outlet 9 and the entire hollow cylinder 41.

A bubbler comprises the flow controller. Other components in the bubbler belong to the prior art, and only an existing flow control part is replaced with the flow controller in this embodiment.

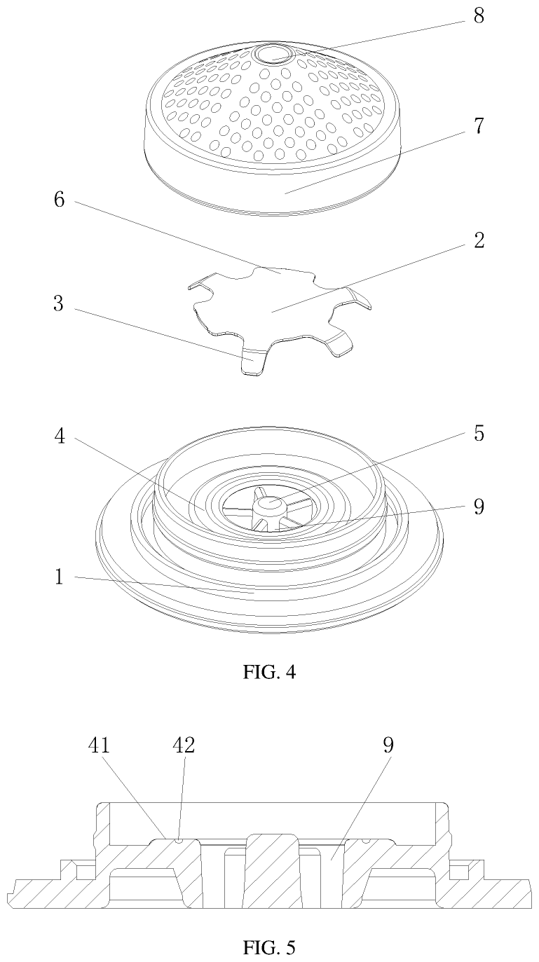

Referring to FIG. 4 and FIG. 5, Embodiment 2 of the invention is as follows:

Referring to Embodiment 1, Embodiment 2 differs from Embodiment 1 in the following aspects:

An annular groove 42 concentric with the hollow cylinder 41 is formed in the top end of the hollow cylinder 41 and is located within the coverage area of the sheet part 2, and the outer diameter of the hollow cylinder 41 is greater than the coverage area of the sheet part 2.

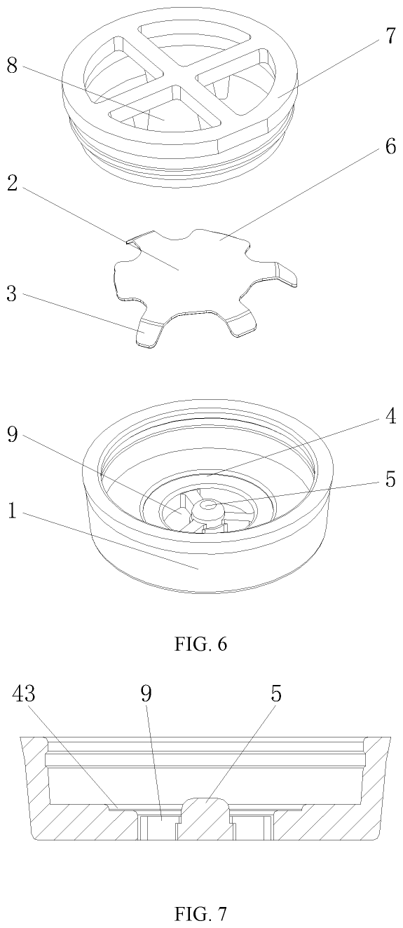

Referring to FIG. 6 and FIG. 7, Embodiment 3 of the invention is as follows:

Referring to Embodiment 1, Embodiment 3 differs from Embodiment 1 in the following aspects:

A limiting rib for partitioning the water hole 8 is disposed at the water hole in the top cover 7, a limiting pillar is disposed on the limiting rib and is located between the top cover 7 and the sheet part 2, and a gap is reserved between the limiting pillar and the sheet part 2.

The flow control part 4 is a circular recessed groove 43 located within the coverage area of the sheet part 2.

A bubbler comprises the flow controller. Other components in the bubbler belong to the prior art, and only an existing flow control part is replaced with the flow controller in this embodiment.

The flow direction of water in the flow controller in this embodiment is shown by the arrows in FIG. 3. A water flow enters the flow controller via the water hole in the top cover and impacts the sheet part to flow to the water outlet in the bottom of the shell along the space between the sheet part and the flow control part; with the increase of the inlet flow, the water pressure borne by the sheet part becomes higher gradually, the legs deform elastically, the sheet part descends, the distance between the sheet part and the flow control part decreases, and the outlet flow is kept constant. The water space between the flow control part and the sheet part changes along with changes of the distance between the flow control part and the sheet part, and the flow area is affected. The flow area is in direct proportion to the outlet flow, the flow control part which is a hollow cylinder is disposed at the bottom of the shell, and the space between the flow control part and the sheet part is small, so that under the same water pressure, the flow area becomes smaller, and the outlet flow is decreased. Similarly, the flow control part with the recessed groove is disposed at the bottom of the shell, and the space between the flow control part and the sheet part is large, so that the flow area is enlarged, and the outlet flow is increased.

To sum up, according to the flow controller and the bubbler provided by the invention, the outlet flow can be controlled, and the precision of the flow area is maintained. The machining difficulty of the flow controller is lowered, and the machining efficiency of the flow controller is improved.

The aforesaid description is merely for explaining the embodiments of the invention, and is not intended to limit the patent scope of the invention. All equivalent transformations made based on the contents of the specification and the drawings, or direct or indirect applications to relating technical fields should also fall within the patent protection scope of the invention.

What is claimed is:

1. A flow controller, comprising a shell and a sheet part, a water outlet being formed in a bottom of the shell, a top of the shell being open, the sheet part covering the water outlet, at least two elastic legs being disposed on the sheet part, and the sheet part being supported in the shell through the legs, wherein a flow control part for changing a distance between the bottom of the shell and the sheet part is disposed around the water outlet, and the sheet part covers at least part of the flow control part.

2. The flow controller according to claim 1, wherein the flow control part is a hollow cylinder, an inner diameter of the hollow cylinder is greater than or equal to a diameter of the water outlet, and a distance between the hollow cylinder and the sheet part is smaller than a distance between the sheet part and the bottom of the shell.

3. The flow controller according to claim 2, wherein a groove is formed in a top end of the hollow cylinder and is located within a coverage area of the sheet part.

4. The flow controller according to claim 1, wherein the flow control part is a recessed groove.

5. The flow controller according to claim 1, further comprising a top cover, wherein a water hole is formed in the top cover, and the top cover is fixedly connected to the top of the shell.

6. The flow controller according to claim 5, wherein a limiting rib for partitioning the water hole is disposed at the water hole in the top cover, a limiting pillar is disposed on the limiting rib and is located between the top cover and the sheet part, and a gap is reserved between the limiting pillar and the sheet part.

7. The flow controller according to claim 5, wherein the top cover is conical, the water hole is formed in a top of the top cover, and at least one auxiliary water hole is formed in a conical surface of the top cover and is smaller than the water hole in size.

8. The flow controller according to claim 1, wherein a partition rib for partitioning the water outlet is disposed at the water outlet, at least one pillar is disposed on the partition rib, a top end of the pillar is higher a top end of the flow control part and is also higher than the bottom of the shell, and a space is reserved between the pillar and the sheet part.

9. The flow controller according to claim 1, wherein at least one extension part is disposed on the sheet part.

10. The flow controller according to claim 2, wherein at least one extension part is disposed on the sheet part.

11. The flow controller according to claim 3, wherein at least one extension part is disposed on the sheet part.

12. The flow controller according to claim 4, wherein at least one extension part is disposed on the sheet part.

13. The flow controller according to claim 5, wherein at least one extension part is disposed on the sheet part.

14. The flow controller according to claim 8, wherein at least one extension part is disposed on the sheet part.

15. A bubble, comprising the flow controller according to claim 1.

16. A bubble, comprising the flow controller according to claim 2.

17. A bubble, comprising the flow controller according to claim 3.

18. A bubble, comprising the flow controller according to claim 4.

19. A bubble, comprising the flow controller according to claim 5.

20. A bubble, comprising the flow controller according to claim 8.
